(19) United States
(12) Patent Application Publication
(10) Pub. No.: US 2023/0132421 A1
(43) Pub. Date: May 4, 2023

(54) METHOD OF RECOGNIZING STOP LINE OF AUTONOMOUS VEHICLE

(71) Applicant: RESEARCH & BUSINESS FOUNDATION SUNGKYUNKWAN UNIVERSITY, Suwon-si (KR)

(72) Inventors: Jaewook JEON, Suwon-si (KR); Hyungjoon JEON, Suwon-si (KR)

(73) Assignee: RESEARCH & BUSINESS FOUNDATION SUNGKYUNKWAN UNIVERSITY, Suwon-si (KR)

(21) Appl. No.: 17/975,915

(22) Filed: Oct. 28, 2022

(30) Foreign Application Priority Data
Oct. 28, 2021 (KR) 10-2021-0145787

(51) Int. Cl. G06V 20/56; G06V 10/70

(52) U.S. Cl. CPC G06V 20/588; G06V 10/70; B60W 60/001

(57) ABSTRACT

A method of recognizing a stop line in an autonomous vehicle is disclosed. The method includes detecting valid stop line data in a current frame of an input image, when the valid stop line data is detected in the current frame, calculating a stop line area in the current frame using a tracking algorithm and tracking the stop line in a next frame, and when the valid stop line data is not detected, inputting the current frame to a trained neural network model and performing a redetection of the stop line data.

### CROSS-REFERENCE TO RELATED APPLICATIONS

This application claims the benefit of Korea Patent Application No. 10-2021-0145787 filed on 28 Oct. 2021, which are incorporated herein by reference for all purposes as if fully set forth herein.

### TECHNICAL FIELD

The present disclosure relates to an autonomous driving technology that recognizes a stop line during autonomous driving even in a harsh environment.

### BACKGROUND

The previously proposed methods detect a stop line based on manually designed logic. Using such a detection system, it is possible to achieve a stop line recognition accuracy of over 90% under normal conditions. However, in hostile conditions including nights and rainy days, there is a problem in that the stop line is not properly recognized. Unlike a self-emitting object (e.g., traffic lights, tail lights, etc.), the stop line is simply a plain road marking painted in white, so the visibility of the stop line is greatly affected by external lighting. Some stop lines are poorly painted, which may cause a hand-coded algorithm, such as line detection, to fail.

In this case, it is not easy to control a vehicle that is autonomously driving. Further, it is virtually impossible to drive the vehicle over a certain speed in order to accurately control the vehicle that is autonomously driving.

### SUMMARY

The present disclosure is proposed to address the above-described and other problems. It is necessary to increase the recognition accuracy by recognizing a stop line based on a deep neural network, and it is also necessary to recognize the stop line at a high speed in order to be used in an actual autonomous vehicle. Accordingly, the present disclosure is to provide a new method of recognizing a stop line capable of recognizing the stop line with real-time speed and very high accuracy.

In order to achieve the above-described and other objects and needs, in one aspect of the present disclosure, there is provided a method of recognizing a stop line in an autonomous vehicle, the method comprising detecting valid stop line data in a current frame of an input image, when the valid stop line data is detected in the current frame, calculating a stop line area in the current frame using a tracking algorithm and tracking the stop line in a next frame, and when the valid stop line data is not detected, inputting the current frame to a trained neural network model and performing a redetection of the stop line data.

According to the present disclosure, an influence of external lighting on visibility of the stop line can be reduced, and the stop line can be properly recognized even in hostile conditions. Therefore, the present disclosure can maintain the speed of the autonomous vehicle as high as possible in harsh environments, such as rainy days and nights, where it is difficult to recognize the stop line.

### BRIEF DESCRIPTION OF THE DRAWINGS

The accompanying drawings, which are included to provide a further understanding of the present disclosure and constitute a part of the detailed description, illustrate embodiments of the present disclosure and serve to explain technical features of the present disclosure together with the description.

FIG. 1 illustrates an autonomous vehicle according to an embodiment of the present disclosure.

FIG. 2 is a control block diagram of an autonomous vehicle according to an embodiment of the present disclosure.

FIG. 3 is a control block diagram of an autonomous device according to an embodiment of the present disclosure.

FIG. 4 illustrates a signal flow in an autonomous vehicle according to an embodiment of the present disclosure.

FIG. 5 is a diagram used for explaining a usage scenario of a user in accordance with an embodiment of the present disclosure.

FIG. 6 is an example of V2X communication to which the present disclosure is applicable.

FIG. 7 illustrates detailed configuration of an object detection device recognizing a stop line in an autonomous vehicle.

FIG. 8 illustrates ResNet-RRC model.

FIG. 9 illustrates a flow recognizing a stop line.

### DETAILED DESCRIPTION

Reference will now be made in detail to embodiments of the present disclosure, examples of which are illustrated in the accompanying drawings.

The present disclosure may, however, be embodied in many different forms and should not be construed as limited to the embodiments set forth herein. In order to clearly explain the present disclosure in the drawings, parts not related to the description may be simplified or omitted. In addition, various embodiments illustrated in the drawings are presented by way of example, and components are simplified and illustrated differently from reality for convenience of description.

In the following detailed description, the same reference numerals are attached to the same components without differences according to embodiments, and the description will not be repeated.

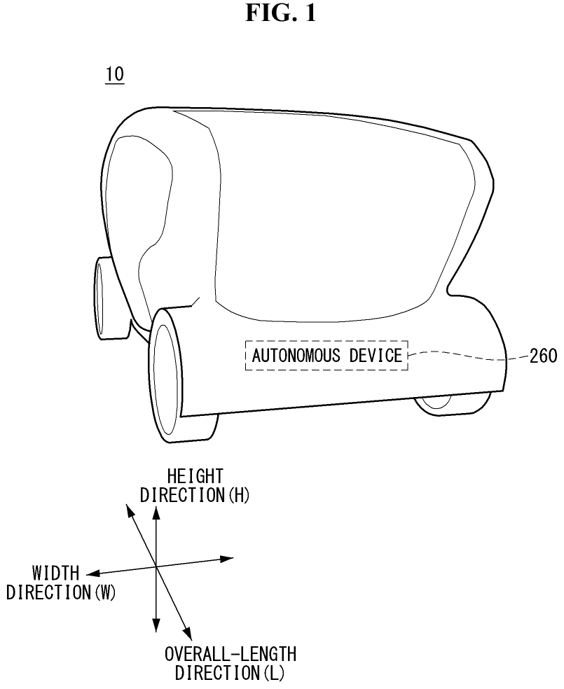

FIG. 1 illustrates an autonomous vehicle according to an embodiment of the present disclosure.

Referring to FIG. 1, an autonomous vehicle 10 according to an embodiment of the present disclosure is defined as a transportation means traveling on roads or railroads. The autonomous vehicle 10 includes a car, a train, and a motorcycle. The autonomous vehicle 10 may include an internal-combustion engine vehicle having an engine as a power source, a hybrid vehicle having an engine and a motor as a power source, and an electric vehicle having an electric motor as a power source. The autonomous vehicle 10 may be a private own vehicle. The autonomous vehicle 10 may be a shared vehicle. The autonomous vehicle 10 may be an autonomous vehicle.

(2) Components of Vehicle

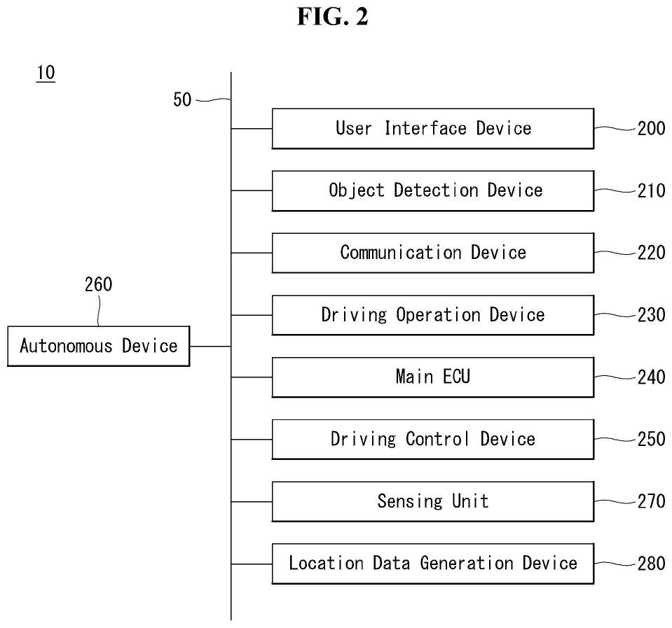

FIG. 2 is a control block diagram of an autonomous vehicle according to an embodiment of the present disclosure.

Referring to FIG. 2, an autonomous vehicle 10 may include a user interface device 200, an object detection device 210, a communication device 220, a driving operation device 230, a main ECU 240, a driving control device 250, an autonomous device 260, a sensing unit 270, and a location data generation device 280. Each of the object detection device 210, the communication device 220, the driving operation device 230, the main ECU 240, the driving control device 250, the autonomous device 260, the sensing unit 270, and the location data generation device 280 may be implemented as an electronic device which generates electric signals and exchange the electric signals from one another.

1) User Interface Device

The user interface device 200 is a device for communication between the autonomous vehicle 10 and a user. The user interface device 200 may receive a user input and provide information generated in the autonomous vehicle 10 to the user. The autonomous vehicle 10 may implement a user interface (UI) or user experience (UX) through the user interface device 200. The user interface device 200 may include an input device, an output device, and a user monitoring device.

2) Object Detection Device

The object detection device 210 may generate information about objects outside the autonomous vehicle 10. The information about objects may include at least one of information on presence or absence of the object, location information of the object, information on a distance between the autonomous vehicle 10 and the object, and information on a relative speed of the autonomous vehicle 10 with respect to the object. The object detection device 210 may detect objects outside the autonomous vehicle 10. The object detection device 210 may include at least one sensor which may detect objects outside the autonomous vehicle 10. The object detection device 210 may include at least one of a camera, a radar, a lidar, an ultrasonic sensor, and an infrared sensor. The object detection device 210 may provide data for an object generated based on a sensing signal generated from a sensor to at least one electronic device included in the vehicle.

2.1) Camera

The camera can generate information about objects outside the autonomous vehicle 10 using images. The camera may include at least one lens, at least one image sensor, and at least one processor which is electrically connected to the image sensor, processes received signals and generates data about objects based on the processed signals. Here, the object may be a stop line.

The camera may be at least one of a mono camera, a stereo camera and an around view monitoring (AVM) camera. The camera can acquire location information of objects, information on distances to objects, or information on relative speeds with respect to objects using various image processing algorithms. For example, the camera can acquire information on a distance to an object and information on a relative speed with respect to the object from an acquired image based on change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera based on disparity information.

The camera may be attached at a portion of the vehicle at which FOV (field of view) can be secured in order to photograph the outside of the vehicle. The camera may be disposed in proximity to the front windshield inside the vehicle in order to acquire front images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information on an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object based on the processed signals. The radar may be implemented as a pulse radar or a continuous wave radar in terms of electromagnetic wave emission. The continuous wave radar may be implemented as a frequency modulated continuous wave (FMCW) radar or a frequency shift keying (FSK) radar according to signal waveform. The radar can detect an object by means of electromagnetic waves based on a time of flight (TOF) method or a phase shift method, and detect a location of the detected object, a distance to the detected object, and a relative speed with respect to the detected object. The radar may be disposed at an appropriate location outside the vehicle in order to detect objects positioned in front of, behind or on the side of the vehicle.

2.3) Lidar

The lidar can generate information about an object outside the autonomous vehicle 10 using a laser beam. The lidar may include a light transmitter, a light receiver, and at least one processor which is electrically connected to the light transmitter and the light receiver, processes received signals and generates data about an object based on the processed signal. The lidar may be implemented by the TOF method or the phase shift method. The lidar may be implemented in a driven type or a non-driven type. A driven type lidar may be rotated by a motor and detect an object around the autonomous vehicle 10. A non-driven type lidar may detect an object positioned within a predetermined range from the vehicle according to light steering. The autonomous vehicle 10 may include a plurality of non-drive type lidars. The lidar can detect an object be means of laser beams based on the TOF method or the phase shift method and detect the location of the detected object, a distance to the detected object, and a relative speed with respect to the detected object. The lidar may be disposed at an appropriate location outside the vehicle in order to detect objects positioned in front of, behind or on the side of the vehicle.

3) Communication Device

The communication device 220 can exchange signals with devices disposed outside the autonomous vehicle 10. The communication device 220 can exchange signals with at least one of infrastructure (e.g., a server and a broadcast station), another vehicle, and a terminal. The communication device 220 may include a transmission antenna, a reception antenna, and at least one of a radio frequency (RF) circuit and an RF element, which can implement various communication protocols, in order to perform communication.

For example, the communication device may exchange signals with the external devices based on C-V2X (cellular V2X) technology. For example, the C-V2X technology may include LTE-based sidelink communication and/or NR-based sidelink communication. The contents related to C-V2X will be described later.

For example, the communication device may exchange signals with the external devices based on dedicated short range communications (DSRC) or wireless access in vehicular environment (WAVE) standards based on IEEE 802.11p PHY/MAC layer technology and IEEE 1609 Network/Transport layer technology. The DSRC (or WAVE standards) is communication specifications for providing an intelligent transport system (ITS) service via short-range dedicated communication between vehicle-mounted devices or between a roadside device and a vehicle-mounted device. The DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device according to the present disclosure can exchange signals with the external devices using only one of C-V2X and DSRC. Alternatively, the communication device according to the present disclosure can exchange signals with the external devices using a hybrid of C-V2X and DSRC.

4) Driving Operation Device

The driving operation device 230 is a device for receiving user input for driving. In a manual mode, the autonomous vehicle 10 may be driven based on a signal provided by the driving operation device 230. The driving operation device 230 may include a steering input device (e.g., a steering wheel), an acceleration input device (e.g., an acceleration pedal), and a brake input device (e.g., a brake pedal).

5) Main ECU

The main ECU 240 can control the overall operation of at least one electronic device included in the autonomous vehicle 10.

6) Driving Control Device

The driving control device 250 is a device for electrically controlling various vehicle driving devices included in the autonomous vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device, and a suspension driving control device. The safety device driving control device may include a seat belt driving control device for seat belt control.

The driving control device 250 includes at least one electronic control device (e.g., a control electronic control unit (ECU)).

The driving control device 250 can control vehicle driving devices based on signals received by the autonomous device 260. For example, the driving control device 250 can control a power train, a steering device and a brake device based on signals received by the autonomous device 260.

7) Autonomous Device

The autonomous device 260 can generate a route for self-driving based on acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one advanced driver assistance system (ADAS) function. The ADAS can implement at least one of adaptive cruise control (ACC), autonomous emergency braking (AEB), forward collision warning (FCW), lane keeping assist (LKA), lane change assist (LCA), target following assist (TFA), blind spot detection (BSD), high beam assist (HBA), auto parking system (APS), a PD collision warning system, traffic sign recognition (TSR), traffic sign assist (TSA), night vision (NV), driver status monitoring (DSM), and traffic jam assist (TJA).

The autonomous device 260 can perform switching from a self-driving mode to a manual driving mode or switching from the manual driving mode to the self-driving mode. For example, the autonomous device 260 can switch the mode of the autonomous vehicle 10 from the self-driving mode to the manual driving mode or from the manual driving mode to the self-driving mode based on a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a location module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor, and a magnetic sensor.

The sensing unit 270 can generate vehicle state data based on a signal generated from at least one sensor. The vehicle state data may be information generated based on data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Location Data Generation Device

The location data generation device 280 can generate location data of the autonomous vehicle 10. The location data generation device 280 may include at least one of a global positioning system (GPS) and a differential global positioning system (DGPS). The location data generation device 280 can generate location data of the autonomous vehicle 10 based on a signal generated from at least one of the GPS and the DGPS. According to an embodiment, the location data generation device 280 can correct location data based on at least one of the inertial measurement unit (IMU) sensor of the sensing unit 270 and the camera of the object detection device 210. The location data generation device 280 may also be called a global navigation satellite system (GNSS).

The autonomous vehicle 10 may include an internal communication system 50. The plurality of electronic devices included in the autonomous vehicle 10 may exchange signals through the internal communication system 50. The signals may include data. The internal communication system 50 may use at least one communication protocol (e.g., CAN, LIN, FlexRay, MOST or Ethernet).

(3) Components of Autonomous Device

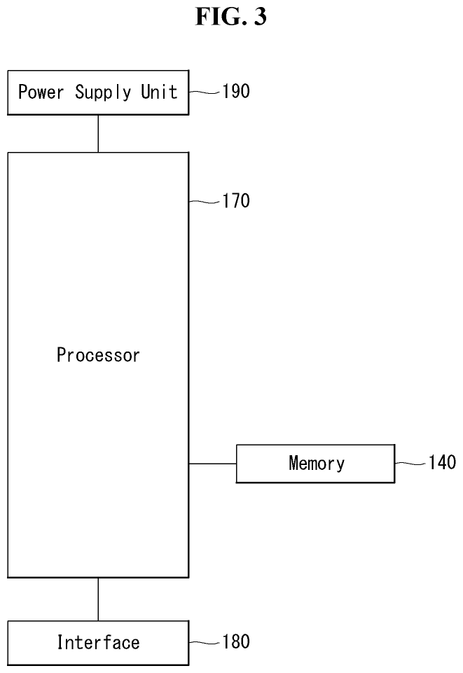

FIG. 3 is a control block diagram of an autonomous device according to an embodiment of the present disclosure.

Referring to FIG. 3, the autonomous device 260 may include a memory 140, a processor 170, an interface 180, and a power supply unit 190.

The memory 140 is electrically connected to the processor 170. The memory 140 can store basic data for units, control data for operation control of units, and input/output data. The memory 140 can store data processed in the processor 170. Hardware-wise, the memory 140 may be configured as at least one of a ROM, a RAM, an EPROM, a flash drive and a hard drive. The memory 140 may store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 may exchange signals with at least one electronic device included in the autonomous vehicle 10 in a wired or wireless manner. The interface 180 may exchange signals with at least one of the object detection device 210, the communication device 220, the driving operation device 230, the main ECU 240, the driving control device 250, the sensing unit 270 and the location data generation device 280 in a wired or wireless manner. The interface 180 may be configured using at least one of a communication module, a terminal, a pin, a cable, a port, a circuit, an element, and a device.

The power supply unit 190 may supply power to the autonomous device 260. The power supply unit 190 may be supplied with power from a power source (e.g., a battery) included in the autonomous vehicle 10 and may supply the power to each unit of the autonomous device 260. The power supply unit 190 may operate in response to a control signal supplied from the main ECU 240. The power supply unit 190 may include a switched-mode power supply (SMPS).

The processor 170 may be electrically connected to the memory 140, the interface 180, and the power supply unit 190 and exchange signals with these components. The processor 170 may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 may operate by power supplied from the power supply unit 190. The processor 170 may receive data, process the data, generate a signal and provide the signal in a state in which power is supplied.

The processor 170 may receive information from other electronic devices included in the autonomous vehicle 10 via the interface 180. The processor 170 may provide control signals to other electronic devices in the autonomous vehicle 10 via the interface 180.

The autonomous device 260 may include at least one printed circuit board (PCB). The memory 140, the interface 180, the power supply unit 190 and the processor 170 may be electrically connected to the PCB.

(4) Operation of Autonomous Device

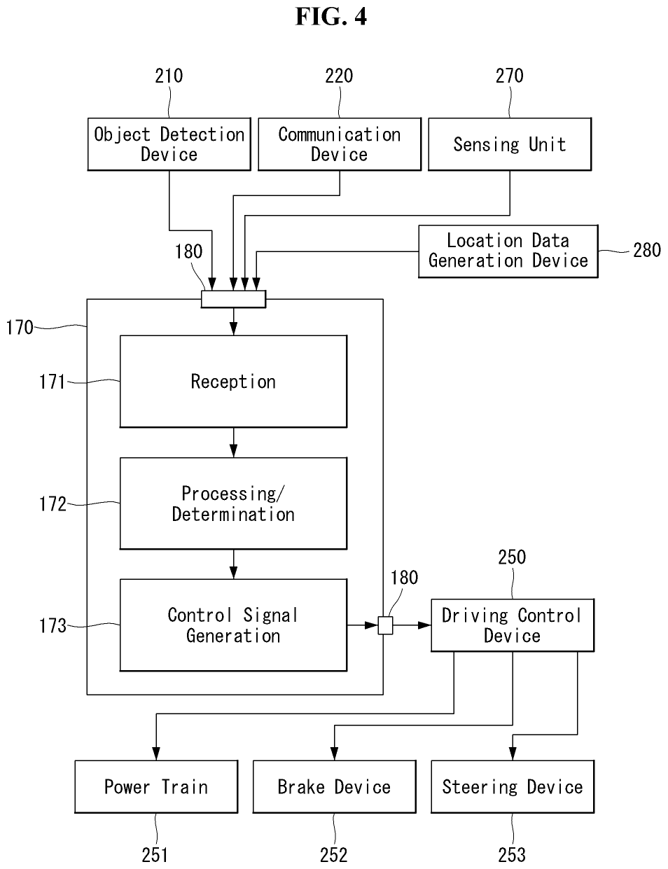

FIG. 4 illustrates a signal flow in an autonomous vehicle according to an embodiment of the present disclosure.

1) Reception Operation

Referring to FIG. 4, the processor 170 may perform a reception operation. The processor 170 may receive data from at least one of the object detection device 210, the communication device 220, the sensing unit 270, and the location data generation device 280 via the interface 180. The processor 170 may receive object data from the object detection device 210. The processor 170 may receive HD map data from the communication device 220. The processor 170 may receive vehicle state data from the sensing unit 270. The processor 170 can receive location data from the location data generation device 280.

2) Processing/Determination Operation

The processor 170 may perform a processing/determination operation. The processor 170 may perform the processing/determination operation based on traveling situation information. The processor 170 may perform the processing/determination operation based on at least one of object data, HD map data, vehicle state data and location data.

2.1) Driving Plan Data Generation Operation

The processor 170 may generate driving plan data. For example, the processor 170 may generate electronic horizon data. The electronic horizon data can be understood as driving plan data in a range from a position at which the autonomous vehicle 10 is located to a horizon. The horizon can be understood as a point a predetermined distance before the position at which the autonomous vehicle 10 is located based on a predetermined traveling route. The horizon may refer to a point at which the vehicle can arrive after a predetermined time from the position at which the autonomous vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated based on data received from an external server through the communication device 220. The topology data may be based on data stored in at least one memory included in the autonomous vehicle 10.

The road data may include at least one of road slope data, road curvature data, road speed limit data, or road lane data including stop lines. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the autonomous vehicle 10 is located to the horizon.

2.1.2) Horizon Path Data

The horizon path data may be explained as a trajectory through which the autonomous vehicle 10 can travel in a range from a position at which the autonomous vehicle 10 is located to the horizon. The horizon path data may include data indicating a relative probability of selecting a road at a decision point (e.g., a fork, a junction, a crossroad, etc.). The relative probability may be calculated based on a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data may include a main path and a sub-path. The main path may be understood as a trajectory obtained by connecting roads having a high relative probability of being selected. The sub-path may be branched from at least one decision point on the main path. The sub-path may be understood as a trajectory obtained by connecting at least one road having a low relative probability of being selected at least one decision point on the main path.

3) Control Signal Generation Operation

The processor 170 can perform a control signal generation operation. The processor 170 can generate a control signal based on the electronic horizon data. For example, the processor 170 may generate at least one of a power train control signal, a brake device control signal and a steering device control signal based on the electronic horizon data.

The processor 170 may transmit the generated control signal to the driving control device 250 via the interface 180. The driving control device 250 may transmit the control signal to at least one of a power train 251, a brake device 252, and a steering device 254.

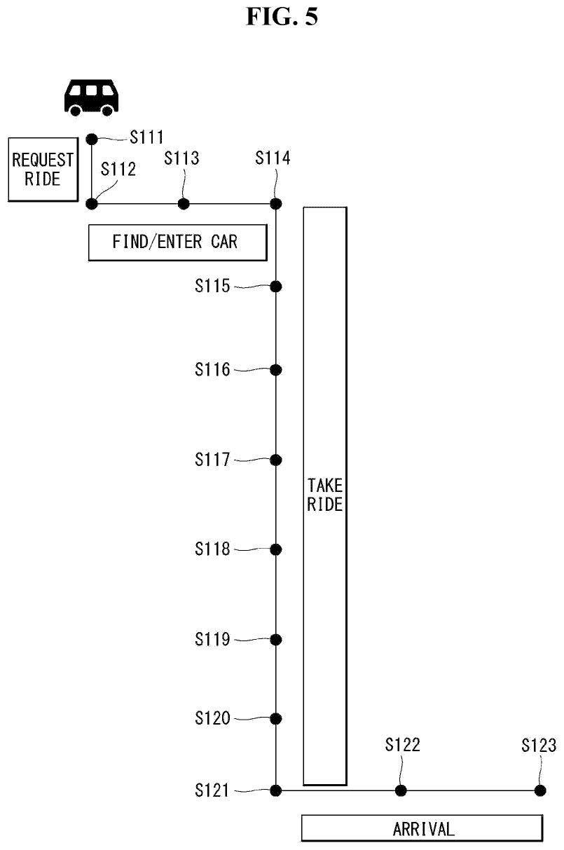

FIG. 5 is a diagram used for explaining a usage scenario of a user in accordance with an embodiment of the present disclosure.

1) Destination Prediction Scenario

A first scenario S111 is a scenario for prediction of a destination of a user. An application which can operate in connection with the cabin system 300 can be installed in a user terminal. The user terminal can predict a destination of a user based on user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can configure a cabin interior layout based on at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may implement a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user based on acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items based on the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user based on the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed based on the electrical signal.

9) AI Agent Scenario

A ninth scenario S119 is a multi-channel artificial intelligence (AI) agent scenario for a plurality of users. The AI agent 372 can distinguish an user input per each of a plurality of users. The AI agent 372 can control at least one of the display system 350, the cargo system 355, the seat system 360, and the payment system 365 in response to electrical signals obtained by converting an individual user input from the plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to the plurality of users through speakers provided for respective seats. The display system 350 can provide content that can be individually viewed by the plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle based on the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data may include data about a total charge for using the autonomous vehicle 10.

Vehicle-to-Everything (V2X)

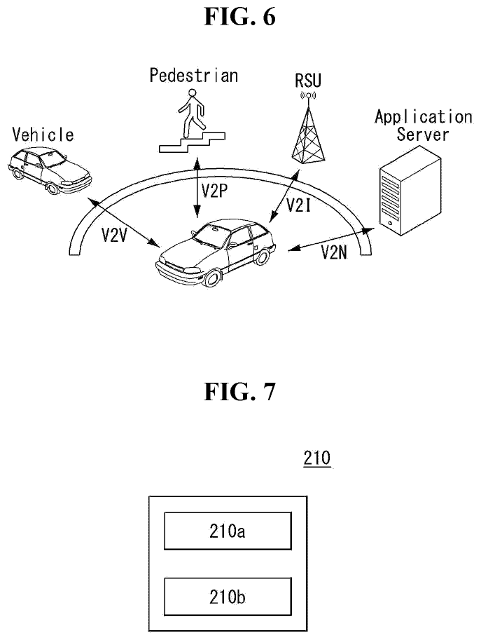

FIG. 6 is an example of V2X communication to which the present disclosure is applicable.

V2X communication includes communication between a vehicle and any entity, such as vehicle-to-vehicle (V2V) referring to communication between vehicles, vehicle-to-infrastructure (V2I) referring to communication between a vehicle and an eNB or a road side unit (RSU), vehicle-to-pedestrian (V2P) referring to communication between a vehicle and a UE carried by a person (e.g., pedestrian, bicycle driver, vehicle driver, or passenger), and vehicle-to-network (V2N).

The V2X communication may refer to the same meaning as V2X sidelink or NR V2X or refer to a wider meaning including V2X sidelink or NR V2X.

The V2X communication is applicable to various services such as forward collision warning, automated parking system, cooperative adaptive cruise control (CACC), control loss warning, traffic line warning, vehicle vulnerable safety warning, emergency vehicle warning, curved road traveling speed warning, and traffic flow control.

The V2X communication may be provided via a PC5 interface and/or a Uu interface. In this case, specific network entities for supporting communication between the vehicle and all the entities may be present in a wireless communication system supporting the V2X communication. For example, the network entity may be a BS (eNB), a road side unit (RSU), a UE, or an application server (e.g., traffic safety server), etc.

Further, the UE performing the V2X communication may refer to a vehicle UE (V-UE), a pedestrian UE, a BS type (eNB type) RSU, a UE type RSU, and a robot with a communication module as well as a handheld UE.

The V2X communication may be directly performed between UEs or performed through the network entities. V2X operation modes may be categorized based on a method of performing the V2X communication.

The V2X communication is required to support pseudonymity and privacy of UEs when a V2X application is used so that an operator or a third party cannot track a UE identifier within an area in which V2X is supported.

The terms frequently used in the V2X communication are defined as follows.
Road Side Unit (RSU): the RSU is a V2X service enabled device which can perform transmission/reception with moving vehicles using a V2I service. In addition, the RSU is a fixed infrastructure entity supporting a V2X application and can exchange messages with other entities supporting the V2X application. The RSU is a term frequently used in the existing ITS specifications and is introduced to 3GPP specifications in order to allow documents to be able to be read more easily in ITS industry. The RSU is a logical entity which combines V2X application logic with the function of a B S (referred to as B S-type RSU) or a UE (referred to as UE-type RSU).
V2I service: A type of V2X service having a vehicle as one side and an entity belonging to infrastructures as the other side.
V2P service: A type of V2X service having a vehicle as one side and a device carried by a person (e.g., a pedestrian, a bicycle rider, a driver or a handheld UE device carried by a fellow passenger) as the other side.
V2X service: A 3GPP communication service type related to a device performing transmission/reception to/from a vehicle.
V2X enabled UE: UE supporting V2X service.
V2V service: A V2X service type having vehicles as both sides.
V2V communication range: A range of direct communication between two vehicles participating in V2V service.

V2X applications called V2X (Vehicle-to-Everything) include four types of (1) vehicle-to-vehicle (V2V), (2) vehicle-to-infrastructure (V2I), (3) vehicle-to-network (V2N) and (4) vehicle-to-pedestrian (V2P) as described above.

A method of recognizing a stop line in the autonomous vehicle 10 during the autonomous driving is described in detail below.

FIG. 7 illustrates detailed configuration of the object detection device 210 recognizing a stop line in the autonomous vehicle 10.

In the present disclosure, the object detection device 210 includes at least two modules for respectively recognizing the stop line depending on a general environment and a harsh environment. The general environment refers to an illuminance environment in which the camera can normally acquire an image of the stop line, and the harsh environment refers to an illuminance environment in which the camera cannot normally acquire an image of the stop line. Examples of the harsh environment include conditions without traffic lights at night, rain conditions, etc.

In the present disclosure, the object detection device 210 may include a recognition module 210a implemented as a neural network model performing residual learning and a tracking module 210b implemented as a median flow tracker.

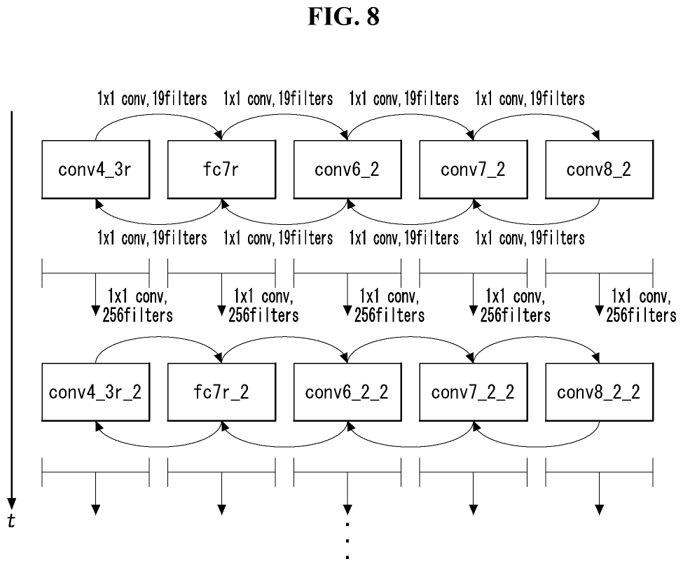

For example, the recognition module 210a is configured as ResNet-RRC model. FIG. 8 illustrates the ResNet-RRC model.

A set of rolling layers described is core components of ResNet-RRC. In the corresponding figure, features of the layer are aggregated into adjacent layers through a rolling operation indicated by a green arrow. The rolling operation includes a convolution operation and an up-convolution operation paired with each convolution operation. Each repeated operation indicated by a red arrow reduces the number of channels in each corresponding rolling layer and performs a transform that allows the layer to return to its original depth. The two operations of the neural network enable strong learning and detection within an input image regardless of a size of an object to be recognized.

Here, ResNet-RRC is a coined word including ResNet and RRC. The ResNet is a neural network model developed to identify an object in an image, and the recurrent rolling convolution (RRC) means a block for identifying a location of the object in the image in the ResNet.

For example, the recognition module 210a analyzes an image acquired from the camera in the general environment to determine whether a stop line is included in the image.

For example, the tracking module 210b is implemented as a median flow tracker that is an algorithm with the highest accuracy and speed among six tracking methods provided by OpenCV library. The tracking algorithm, the median flow tracker is described in detail in “Z. Kalal et al., “Forward-backward error: Automatic detection of tracking failures.” 2010 20th International Conference on Pattern Recognition, pages 2756-2759. IEEE, 2010”, and thus detailed description is omitted.

If a stop line area of a next frame among frames (or images) acquired through the camera is successfully detected by the track of the tracking module 210b, the corresponding area is selected as an output. Otherwise, tracking data is deleted, and a scene frame is input to the recognition module 210a. If there is no valid tracking data, the recognition module 210a is directly used in the input frame.

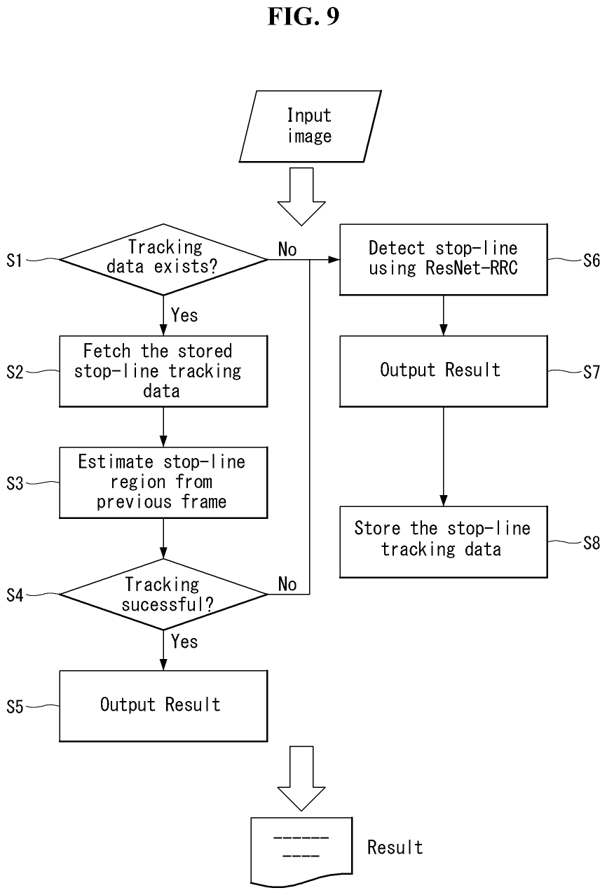

A flow recognizing a stop line in the autonomous vehicle 10 is described below with reference to FIG. 9. FIG. 9 illustrates a flow recognizing a stop line. In the following description, it is assumed that the camera acquires a driving image (or frame) in real time while the autonomous vehicle is autonomously driving. For example, the camera acquires a predetermined image, such as 30 frames per second or 60 frames per second, in real time and inputs it to the object detection apparatus 10.

In a first step S1, before an image is input to the recognition module 210a in real time, the device checks whether there is a valid stop line that is currently being tracked.

In the first step S1, if there is the valid stop line (tracking data) being tracked (i.e., if it is determined that there is a stop line in a previous frame), the tracking module 210b is activated and searches for a stop line in a next input frame, in S2 and S3.

In a fourth step S4, if a stop line area is successfully detected in the next frame, the corresponding stop line area is selected as an output, in S5.

In the fourth step S4, if the stop line area is not detected in the next frame, the tracking data is deleted, and the next frame is input to the recognition module 210a which is a trained neural network model, in S6.

The recognition module 210a tracks whether the stop line area exists based on deep learning in the next input frame in S7, and if the stop line area exists as a result of tracking, it is stored as the valid stop line (tracking data) in S8. The stored valid stop line (tracking data) is the basis for determining whether the valid stop line exists in the first step S1.

As described above, if there is no valid stop line area (tracking data) in the frame, the present disclosure may input an input frame to the recognition module 210a to double recognition performance.

The effects of the present disclosure described above are described below.

As a dataset for training and inferring the neural network model constituting the recognition module 210a, a self-collected dataset and Oxford Robotcar Dataset were used. The computer specifications used in an experiment are presented in Table 1.

TABLE 1
< Computer specifications used in experiment >

| | |
|---|---|
| CPU | Intel ® Core ™ i9-7980XE |
| GPU | NVIDIA ® GeForce ® GTX |
| | Titan Xp Collectors Edition (×4) |
| GPU Driver | CUDA 10.1 + cuDNN 7.6.5 |
| Framework | OpenCV2 + Tensorflow 2.3 |
| Programming | Python |
| Language | |
| Operating System | Ubuntu 18.04 |

First, using its own dataset, an experiment was performed to measure the recognition speed and accuracy of each of various tracking algorithms as well as the stop line recognition using the recognition module 210a. The experimental result is shown in Table 2.

TABLE 2
< System result of stop line recognition on
self-collected dataset for each tracking algorithm >

| Tracking Algorithm | Speed (fps) | Accuracy (%) |
|---|---|---|
| None | 13.9 | 94.95 |
| CSRT | 13.6 | 32.8 |
| KCF | 3.5 | 52.52 |
| MedianFlow | 37.6 | 96.24 |
| MIL | 13 | 22.48 |
| MOSSE | 16.7 | 88.3 |
| TLD | 9.68 | 28.9 |

As can be seen from the experimental result, if there was no tracking algorithm in the stop line recognition system, the recognition speed was a whopping 13.9 fps, and the recognition accuracy was 94.95%. If the MedianFlow tracking algorithm was also used, the recognition speed increased to 30 fps or more, and the recognition accuracy was 96.24%. Among the six tracking methods that have been actually tested, it can be seen that the MedianFlow tracking algorithm was only a tracking algorithm that improved both the recognition speed and the recognition accuracy, compared to when no tracking algorithm was used. Hence, the MedianFlow tracking algorithm was selected as the tracking algorithm to be used in the stop line recognition system.

Now, using the Oxford Robotcar Dataset, an experiment was performed to measure the recognition accuracy and recognition speed of the stop line under various conditions. The experimental results are shown in Table 3.

TABLE 3
< System result of stop line recognition on Oxford
Robotcar Dataset based on the presence or absence
of tracking algorithm and each environmental condition >

| Presence or | | | | | |
|---|---|---|---|---|---|
| tracking | | | | | |
| algorithm | Speed | Accuracy (%) | | | |
| absence of | (fps) | Normal | Poor paint | Poor lighting | Average |
| Presence | 14 | 98.4 | 78.32 | 81.25 | 86.58 |
| Absence | 23.9 | 95.72 | 79.2 | 76.56 | 85.32 |

As can be seen from Table 3, there was no significant difference in the average accuracy of stop line recognition regardless of the presence or absence of the tracking algorithm. In both the two cases (the presence and absence), it was possible to recognize the stop line with a high accuracy of 95% or more under the normal conditions. Further, even under poor paint or poor lighting conditions, it was possible to recognize the stop line with a fairly high accuracy of 75% or more.

Although the present disclosure has been described focusing on the above-described embodiments, they are merely examples and do not limit the present disclosure. Thus, those skilled in the art to which the present disclosure pertains will know that various modifications and applications which have not been exemplified can be performed within the range without departing from the essential features of these embodiments.

What is claimed is:

1. A method of recognizing a stop line in an autonomous vehicle, the method comprising:
detecting valid stop line data in a current frame of an input image;
when the valid stop line data is detected in the current frame, calculating a stop line area in the current frame using a tracking algorithm and tracking the stop line in a next frame; and
when the valid stop line data is not detected, inputting the current frame to a trained neural network model and performing a redetection of the stop line data.

2. The method of claim 1, further comprising:
when the neural network model detects the stop line data in the current frame, transmitting the detected stop line data to the tracking algorithm, and tracking, by the tracking algorithm, the stop line in the next frame based on the transmitted stop line data.

3. The method of claim 1, wherein the tracking algorithm is a median flow tracker.

4. The method of claim 1, wherein the neural network model is a ResNet-RRC model.
